(19) United States
(12) Patent Application Publication
(10) Pub. No.: US 2021/0364937 A1
(43) Pub. Date: Nov. 25, 2021

(54) ELECTROPHOTOGRAPHIC PHOTOSENSITIVE MEMBER, PROCESS CARTRIDGE AND ELECTROPHOTOGRAPHIC APPARATUS

(71) Applicant: CANON KABUSHIKI KAISHA, Tokyo (JP)

(72) Inventors: Jumpei Kuno, Kanagawa (JP); Taichi Sato, Shizuoka (JP)

(21) Appl. No.: 17/315,851

(22) Filed: May 10, 2021

(30) Foreign Application Priority Data
May 19, 2020 (JP) 2020-087657

(51) Int. Cl. G03G 5/047; G03G 5/14

(52) U.S. Cl. CPC G03G 5/047; G03G 5/144

(57) ABSTRACT

The present disclosure provides an electrophotographic photosensitive member that can obtain a satisfactory image free from the image defect such as the interference fringes as an electrophotographic photosensitive member, and can achieve high fineness in an output image. The electrophotographic photosensitive member includes a support, an electroconductive layer and a photosensitive layer, in this order, wherein the electroconductive layer comprises a binder resin, a metal oxide particle and a silica particle, a content of the metal oxide particle in the electroconductive layer is 20.0 to 60.0% by volume with respect to total volume of the electroconductive layer, the metal oxide particle has an average primary particle diameter of 50 to 500 nm, and the silica particle has an average primary particle diameter of 10 to 300 nm.

### BACKGROUND OF THE INVENTION

### Field of the Invention

The present disclosure relates to an electrophotographic photosensitive member, and a process cartridge and an electrophotographic apparatus which include the electrophotographic photosensitive member.

### Description of the Related Art

It is known that an electroconductive layer containing a metal oxide particle is provided between a support and a photosensitive layer in an electrophotographic photosensitive member which is used for an electrophotographic apparatus, for the purpose of concealing defects on the surface of the support. In order to achieve the above object, the electroconductive layer needs to contain the metal oxide particle having a high optical hiding power and a binder resin for binding such particles. Furthermore, it has been proposed to add a particle having a void therein in combination with the metal oxide particle, for the purpose of stabilizing a coating liquid, optimizing charging characteristics of a photosensitive member, and suppressing the residual electric potential (Japanese Patent Application Laid-Open No. 2009-15112).

In addition, in recent years, enhancement of definition of an output image by electrophotography has been advanced. It is known that reduction in a diameter of an irradiation spot of image exposure light and reduction in a diameter of a toner particle are effective for enhancing the definition of the output image. In addition to these, it is known that the definition of the output image can vary depending on the charging characteristics of the electrophotographic photosensitive member, and the like.

### SUMMARY OF THE INVENTION

According to studies by the present inventors, it has been found that there is room for improvement in terms of the fineness in the output image, in the electrophotographic photosensitive member described in Japanese Patent Application Laid-Open No. 2009-15112.

Accordingly, the purpose of the present disclosure is to provide an electrophotographic photosensitive member that can obtain a satisfactory image free from an image defect such as interference fringes, and can achieve high fineness in the output image.

The above object is achieved by the following present disclosure. Specifically, the electrophotographic photosensitive member according to the present disclosure is an electrophotographic photosensitive member having a support, an electroconductive layer and a photosensitive layer, in this order, wherein the electroconductive layer comprises a binder resin, a metal oxide particle and a silica particle, a content of the metal oxide particle in the electroconductive layer is 20.0 to 60.0% by volume with respect to total volume of the electroconductive layer, the metal oxide particle has an average primary particle diameter of 50 to 500 nm, and the silica particle has an average primary particle diameter of 10 to 300 nm.

According to the present disclosure, an electrophotographic photosensitive member can be provided that can obtain a satisfactory image free from the image defect such as the interference fringes and can achieve the high fineness in the output image.

Further features of the present disclosure will become apparent from the following description of exemplary embodiments with reference to the attached drawings.

### BRIEF DESCRIPTION OF THE DRAWINGS

FIG. 1 illustrates a view illustrating one example of a schematic configuration of an electrophotographic apparatus provided with a process cartridge that includes an electrophotographic photosensitive member.

FIG. 2 illustrates a top view for describing a method of measuring the volume resistivity of an electroconductive layer.

FIG. 3 illustrates a cross-sectional view for describing the method of measuring the volume resistivity of the electroconductive layer.

FIG. 4 illustrates an image pattern which has been used for image evaluation.

### DESCRIPTION OF THE EMBODIMENTS

Preferred embodiments of the present disclosure will now be described in detail in accordance with the accompanying drawings.

The present disclosure will be described below in detail with reference to exemplary embodiments.

In Japanese Patent Application Laid-Open No. 2009-15112, it is proposed that when an intermediate layer contains a particle having a void in the inner part, in addition to a metal oxide, a moire resistance effect is obtained. The reason for this effect is considered to be because in a case of the particle having the void in the inner part, in addition to light scattering at an internal void portion thereof, light scattering on the surface is promoted, and a high image quality can be achieved due to high moire resistance.

Because the particle for obtaining the above effect needs to have the internal void portion, and the particle itself needs to generate light scattering, the particle needs to have a certain degree of size. On the other hand, as a result of studies by the present inventors, it has been found that when large particles are contained in the electroconductive layer, convex and concave in a film thickness of a charge generation layer occurs due to unevenness of the surface of the electroconductive layer, and it becomes difficult to obtain fine line reproducibility in some cases.

In order to solve the technical problems that have occurred in the above conventional technology, the present inventors have studied the particle to be used in the electroconductive layer. As a result of the above study, it has been found that when a content of the metal oxide particle in the electroconductive layer is 20.0 to 60.0% by volume with respect to total volume of the electroconductive layer, the metal oxide particle has an average primary particle diameter of 50 to 500 nm, and the silica particle has an average primary particle diameter of 10 to 300 nm, the technical problems that have occurred in the conventional technology can be solved.

Specifically, the electrophotographic photosensitive member of the present disclosure is an electrophotographic photosensitive member that has a support, an electroconductive layer and a photosensitive layer, in this order, wherein the electroconductive layer comprises a binder resin, a metal oxide particle and a silica particle, a content of the metal oxide particle in the electroconductive layer is 20.0 to 60.0% by volume with respect to total volume of the electroconductive layer, the metal oxide particle has an average primary particle diameter of 50 to 500 nm, and the silica particle has an average primary particle diameter of 10 to 300 nm.

In the electrophotographic photosensitive member of the present disclosure, the electroconductive layer has the above configuration, and thereby the electrophotographic photosensitive member is obtained that can provide an image in which interference fringes are suppressed and fine line reproducibility is excellent.

The present inventors consider this reason in the following way.

The electroconductive layer of the present disclosure has the above configuration, and thereby the surface of the electroconductive layer has fine convex and concave. Due to the unevenness, the electrophotographic photosensitive member is obtained that can provide the image in which the interference fringes are suppressed and the fine line reproducibility is excellent. On the other hand, in the case where the particle having the void in the inner part is used, which is described in Japanese Patent Application Laid-Open No. 2009-15112, large unevenness is formed on the surface of the electroconductive layer because the size of the particle is too large, and as a result, convex and concave occurs in the film thickness of the charge generation layer, and it becomes difficult to obtain the fine line reproducibility, in some cases. In addition, this fine unevenness on the surface of the electroconductive layer varies depending on the average primary particle diameter of the metal oxide particles, the average primary particle diameter of the silica particles, and a content state in which the metal oxide particles and the silica particles are contained. Accordingly, when the electroconductive layer has the above configuration, the electrophotographic photosensitive member can suitably obtain the effect of the present disclosure.

As in the above mechanism, the configurations synergistically exert the effects to each other, and thereby the electrophotographic photosensitive member can achieve the effects of the present disclosure.

[Electrophotographic Photosensitive Member]

The electrophotographic photosensitive member of the present disclosure includes a support, an electroconductive layer and a photosensitive layer, in this order.

Examples of a method for manufacturing the electrophotographic photosensitive member of the present disclosure include a method of: preparing coating liquids for each layer, which will be described later; applying the coating liquids in order of desired layers, respectively; and drying the coating liquids. Examples of application methods of the coating liquid at this time include dip coating, spray coating, ink jet coating, roll coating, die coating, blade coating, curtain coating, wire bar coating and ring coating. Among the methods, the dip coating is preferable from the viewpoints of efficiency and productivity.

The support and each of the layers will be described below.

<Support>

In the present disclosure, the electrophotographic photosensitive member has the support. In the present disclosure, it is preferable that the support is an electroconductive support having electroconductivity. In addition, shapes of the support include a cylindrical shape, a belt shape and a sheet shape. Among the supports, the cylindrical support is preferable. In addition, the surface of the support may be subjected to electrochemical treatment such as anodic oxidation, blast treatment, centerless grinding treatment, cutting treatment and the like.

As a material of the support, a metal, a resin, glass and the like are preferable.

Examples of the metal include aluminum, iron, nickel, copper, gold, stainless steel, and alloys thereof. Among the metals, an aluminum support using aluminum is preferable.

In addition, the electroconductivity may be imparted to the resin or the glass by treatment such as mixing of or coating with an electroconductive material.

<Electroconductive Layer>

In the present disclosure, the electroconductive layer is formed on the support, and contains a binder resin, metal oxide particles and silica particles. In this case, the content of the metal oxide particle in the electroconductive layer is 20.0 to 60.0% by volume with respect to total volume of the electroconductive layer, the metal oxide particle has an average primary particle diameter of 50 to 500 nm, and the silica particle has an average primary particle diameter of 10 to 300 nm.

By satisfying the above configuration, the electrophotographic photosensitive member can be obtained that can provide an image in which the interference fringes are suppressed and the fine line reproducibility is excellent.

A content of the metal oxide particles in the present disclosure can be calculated as the content of the particles in the total volume of the electroconductive layer, from a difference among contrasts in Slice & View in FIB-SEM, for example.

In the present disclosure, it is preferable that the content of the metal oxide particles in the total volume of the electroconductive layer is 20.0 to 60.0% by volume. When the content of the metal oxide particles is 20.0% by volume or more, the electroconductive layer can improve a hiding property, and can satisfactorily suppress an image defect originating in the support. When the content of the metal oxide particles is 60.0% by volume or less, properties of the coating film are satisfactory, and a fine image tends to be easily obtained.

The average primary particle diameter of the metal oxide particles in the present disclosure was determined using a scanning electron microscope, in the following way. The particle to be measured has been observed using a scanning electron microscope S-4800 manufactured by Hitachi, Ltd.; the particle diameter of each of 100 particles was measured from an image obtained by observation; and an arithmetic average thereof was calculated, and was determined to be an average primary particle diameter. Each particle diameter was determined to be (a+b)/2, at the time when the longest side of the primary particle was defined as a, and the shortest side was defined as b. In addition, in the case of a needle-shaped metal oxide particle or a thin slice-shaped metal oxide particle, an average primary particle diameter was calculated for each of a major axis diameter and a minor axis diameter.

In the present disclosure, it is preferable that the average primary particle diameter of the metal oxide particles is 50 to 500 nm. When the particle diameter is 50 nm or larger, the electroconductive layer can improve the hiding property, and can satisfactorily suppress the image defect originating in the support. When the particle diameter is 500 nm or smaller, the properties of the coating film are satisfactory, and the fine image tends to be easily obtained. Furthermore, in the present disclosure, it is more preferable that the average primary particle diameter of the metal oxide particles is 100 to 400 nm.

In the present disclosure, the surface of the metal oxide particle may be treated with a silane coupling agent or the like.

In the metal oxide particles in the present disclosure, the layered structure can also be suitably used that has a core material containing titanium oxide and a covering layer with which the core material is covered. When the metal oxide particle having the layered structure is used, it is easy to achieve both a high refractive index and the aimed resistivity, and it is easy to achieve both effects of suppressing the interference fringes and the fine line reproducibility, in the present disclosure.

The electroconductive layer of the present disclosure may contain another type of electroconductive particle in addition to the above metal oxide particle. Examples of another type of electroconductive particle include a metal oxide, a metal and carbon black.

Examples of the metal oxide include zinc oxide, aluminum oxide, indium oxide, silicon oxide, zirconium oxide, tin oxide, titanium oxide, magnesium oxide, antimony oxide and bismuth oxide. Examples of the metal include aluminum, nickel, iron, nichrome, copper, zinc and silver.

When a metal oxide is used as another type of electroconductive particle, the surface of the metal oxide may be treated with a silane coupling agent or the like, or the metal oxide may be doped with an element such as phosphorus or aluminum, or an oxide thereof.

In addition, another type of electroconductive particle may have a layered structure that has a core material and a covering layer with which the core material is covered. Examples of the core material include titanium oxide, barium sulfate and zinc oxide. Examples of the covering layer include a metal oxide such as titanium oxide and tin oxide.

When a metal oxide is used as the electroconductive particle other than the titanium oxide in the present disclosure, it is preferable for the average primary particle diameter to be 50 to 500 nm, and is more preferable to be 100 to 300 nm. When the particle diameter is 50 nm or larger, the electroconductive layer can improve the hiding property, and can satisfactorily suppress the image defect originating in the support. When the particle diameter is 500 nm or smaller, the property of the coating film is satisfactory, and a fine image tends to be easily obtained.

It is preferable for an average primary particle diameter of the silica particles of the present disclosure to be 10 to 300 nm, and is more preferable to be 10 to 100 nm. When the particle diameter is 10 nm or larger, re-agglomeration tends to be relatively easily controlled, and a coating film can be stably formed. When the particle diameter is 300 nm or smaller, the property of the coating film is satisfactory, and a fine image tends to be easily obtained.

In the present disclosure, it is preferable that the content of the silica particles in the total volume of the electroconductive layer is 0.10 to 5.00% by volume. Furthermore, it is particularly preferable to be 0.10 to 2.00% by volume. When the content of the silica particles is 0.10% by volume or more, fine unevenness sufficient to suppress the interference fringes tends to be easily obtained. When the content of the silica particles is 5.00% by volume or less, properties of the coating film are satisfactory, and a fine image tends to be easily obtained.

The type of silica particle to be used in the present disclosure is not particularly limited. The silica particle may be obtained by any of wet methods such as a sol-gel method and a water glass method, and a dry method such as a gas phase method. In addition, the surface of the silica particle may be treated with a silane coupling agent or the like.

The shape of the silica particles at the time of addition may be powdery, or the silica particles may be added in a slurry state in which the silica particles are dispersed in a solvent.

Examples of the binder resin include a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a silicone oil, a resin particle and the like.

It is preferable for an average film thickness of the electroconductive layer to be 5 to 50 μm, and is particularly preferable to be 10 to 35 μm. When the average film thickness of the electroconductive layer is 5 μm or larger, the hiding property is high and the image defect originating in the support can be satisfactorily suppressed. When the average film thickness of the electroconductive layer is 50 μm or smaller, retention of electric charge becomes small, sensitivity of the photosensitive member does not deteriorate by durability, and a fine image tends to be easily obtained.

In the present disclosure, it is preferable that the volume resistivity (powder resistivity) of the particle as powder is preferably 1.0×10¹ to 1.0×10⁸ Ω·cm. If the powder resistivity is lower than this range, a local electric current tends to easily flow, and an image defect such as a leak image tends to easily occur. If the powder resistivity is higher than this range, the retention of electric charge becomes large, the sensitivity of the photosensitive member deteriorates by durability, and a fine image is not obtained, in some cases. In the present disclosure, the powder resistivity of the particle is measured under an environment of normal temperature and normal humidity (temperature 23° C./relative humidity 50%). In the present disclosure, a resistivity meter Loresta-GP manufactured by Mitsubishi Chemical Corporation was used as a measuring apparatus. The particles to be measured in the present disclosure were compacted under a pressure of 500 kg/cm′ and were formed into a sample for measurement having a pellet shape. The voltage to be applied was set at 100 V.

In the present disclosure, it is preferable that the volume resistivity of the electroconductive layer is 1.0×10⁸ to 1.0×10¹³ Ω·cm. When the volume resistivity of the electroconductive layer is 1.0×10¹³ Ω·cm or smaller, it becomes difficult that the flow of electric charge stagnates during image formation, and it becomes difficult that a residual electric potential increases, and it becomes more difficult that a light portion potential varies. On the other hand, when the volume resistivity of the electroconductive layer is 1.0×10⁸ Ω·cm or larger, it becomes difficult that the amount of electric charge becomes too large which flows through the electroconductive layer when the electrophotographic photosensitive member is electrically charged, and it becomes difficult that leakage occurs. Furthermore, it is more preferable that the volume resistivity of the electroconductive layer is 1.0×10⁸ to 1.0×10¹² Ω·cm.

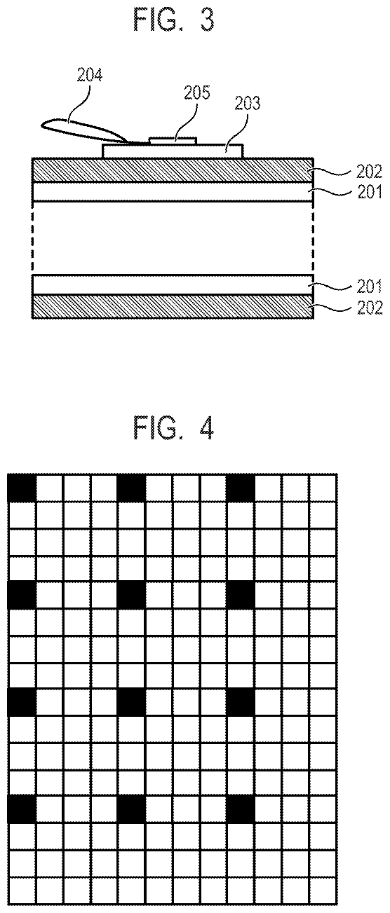

A method of measuring the volume resistivity of the electroconductive layer of the electrophotographic photosensitive member will be described below with reference to FIGS. 2 and 3. FIG. 2 illustrates a top view for describing the method of measuring the volume resistivity of the electroconductive layer, and FIG. 3 illustrates a cross-sectional view for describing the method of measuring the volume resistivity of the electroconductive layer.

The volume resistivity of the electroconductive layer is measured under an environment of normal temperature and normal humidity (temperature 23° C./relative humidity 50%). A copper tape 203 (manufactured by Sumitomo 3M Limited, Model number No. 1181) is attached to the surface of an electroconductive layer 202, and shall be an electrode on the front face side of the electroconductive layer 202. In addition, a support 201 shall be an electrode on the back side of the electroconductive layer 202. A power source 206 for applying a voltage between the copper tape 203 and the support 201, and an electric current measuring device 207 for measuring an electric current flowing between the copper tape 203 and the support 201 are each installed. In addition, in order to apply a voltage to the copper tape 203, a copper wire 204 is placed on the copper tape 203, a copper tape 205 similar to the copper tape 203 is attached to the copper wire 204 from above so that the copper wire 204 is not detached from the copper tape 203, and the copper wire 204 is fixed to the copper tape 203. A voltage is applied to the copper tape 203 using the copper wire 204.

When a background electric current value at the time when the voltage is not applied between the copper tape 203 and the support 201 is represented by I₀(A), an electric current value at the time when a voltage of only direct current voltage (direct current component) of −1 V has been applied is represented by I(A), a film thickness of the electroconductive layer 202 is represented by d (cm), and an area of the electrode (copper tape 203) on the front face side of the electroconductive layer 202 is represented by S (cm²), a value calculated by Expression [ρ=1/(I−I₀)×S/d] is defined as the volume resistivity ρ (Ω·cm) of the electroconductive layer 202.

In this measurement, a minute electric current amount of 1×10⁻⁶ A or smaller in terms of an absolute value is measured, and accordingly it is preferable to use a device which can measure a minute electric current, for the electric current measuring device 207. Examples of such a device include a pA meter 4140B manufactured by Hewlett Packard Enterprise. For information, the volume resistivity of the electroconductive layer shows a similar value, when measured in a state where only the electroconductive layer is formed on the support, and also when measured in a state where each layer (photosensitive layer or the like) on the electroconductive layer is peeled from the electrophotographic photosensitive member and only the electroconductive layer is left on the support.

The electroconductive layer can be formed by operations of: preparing a coating liquid for the electroconductive layer, which contains each of the above materials and a solvent; forming a coating film of the coating liquid on the support; and drying the coating film. Examples of the solvent to be used for the coating liquid for the electroconductive layer include an alcohol-based solvent, a sulfoxide-based solvent, a ketone-based solvent, an ether-based solvent, an ester-based solvent and an aromatic hydrocarbon-based solvent. Examples of dispersion methods for dispersing the electroconductive particles in the coating liquid for the electroconductive layer include a method using a paint shaker, a sand mill, a ball mill, or a liquid collision type high speed disperser. The coating liquid for the electroconductive layer, which has been prepared by dispersion, may be subjected to filtration for removing components that are unnecessary for the coating liquid for the electroconductive layer.

<Undercoat Layer>

In the present disclosure, an undercoat layer may also be provided on the electroconductive layer. The undercoat layer which has been provided can thereby enhance an adhesion function between layers and impart a charge injection inhibition function.

It is preferable that the undercoat layer contains a resin. In addition, the undercoat layer may be formed as a cured film by polymerization of a composition which contains a monomer having a polymerizable functional group.

Examples of the resin include a polyester resin, a polycarbonate resin, a polyvinyl acetal resin, an acrylic resin, an epoxy resin, a melamine resin, a polyurethane resin, a phenol resin, a polyvinyl phenol resin, an alkyd resin, a polyvinyl alcohol resin, a polyethylene oxide resin, a polypropylene oxide resin, a polyamide resin, a polyamic acid resin, a polyimide resin, a polyamide imide resin and a cellulose resin.

Examples of the polymerizable functional group which the monomer having the polymerizable functional group has include an isocyanate group, a blocked isocyanate group, a methylol group, an alkylated methylol group, an epoxy group, a metal alkoxide group, a hydroxyl group, an amino group, a carboxyl group, a thiol group, a carboxylic acid anhydride group and a carbon-carbon double bond group.

In addition, the undercoat layer may further contain an electron transport substance, a metal oxide, a metal, an electroconductive polymer and the like, for the purpose of enhancing the electric characteristics. Among the materials, it is preferable to use the electron transport substance and the metal oxide.

Examples of the electron transport substance include a quinone compound, an imide compound, a benzimidazole compound, a cyclopentadienylidene compound, a fluorenone compound, a xanthone compound, a benzophenone compound, a cyanovinyl compound, a halogenated aryl compound, a silole compound and a boron-containing compound. The undercoat layer may be formed as a cured film, by using an electron transport substance having a polymerizable functional group as the electron transport substance, and copolymerizing the electron transport substance with a monomer having the above polymerizable functional group.

Examples of the metal oxide include indium tin oxide, tin oxide, indium oxide, titanium oxide, zinc oxide, aluminum oxide and silicon dioxide. Examples of the metal include gold, silver and aluminum.

As the electroconductive polymer, an electroconductive polymer compound such as polyaniline, polypyrrole and polyacetylene can be used.

In addition, the undercoat layer may also further contain an additive.

It is preferable for an average film thickness of the undercoat layer to be 0.1 to 50 μm, is more preferable to be 0.2 to 40 μm, and is particularly preferable to be 0.3 to 30 μm.

The undercoat layer can be formed by operations of: preparing a coating liquid for the undercoat layer, which contains each of the above materials and a solvent; forming a coating film of the coating liquid on the electroconductive layer; and drying and/or curing the coating film. Examples of the solvent to be used for the coating liquid for the undercoat layer include an alcohol-based solvent, a ketone-based solvent, an ether-based solvent, an ester-based solvent and an aromatic hydrocarbon-based solvent.

<Photosensitive Layer>

The photosensitive layer of the electrophotographic photosensitive member is mainly classified into (1) a multilayer type photosensitive layer, and (2) a single-layer type photosensitive layer. (1) The multilayer type photosensitive layer includes a charge generation layer containing a charge generation substance, and a charge transport layer containing a charge transport substance. (2) The single-layer type photosensitive layer is a photosensitive layer containing both of the charge generation substance and the charge transport substance.

(1) Multilayer Type Photosensitive Layer

The multilayer type photosensitive layer includes the charge generation layer and the charge transport layer.

(1-1) Charge Generation Layer

It is preferable that the charge generation layer contains the charge generation substance and a resin.

Examples of the charge generation substance include an azo pigment, a perylene pigment, a polycyclic quinone pigment, an indigo pigment and a phthalocyanine pigment. Among the pigments, the azo pigment and the phthalocyanine pigment are preferable. Among the phthalocyanine pigments, oxytitanium phthalocyanine pigment, chlorogallium phthalocyanine pigment and hydroxygallium phthalocyanine pigment are preferable.

It is preferable for a content of the charge generation substance in the charge generation layer to be 40 to 85% by mass, and is more preferable to be 60 to 80% by mass, with respect to the total mass of the charge generation layer.

Examples of the resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among the resins, the polyvinyl butyral resin is more preferable.

In addition, the charge generation layer may further contain additives such as an antioxidizing agent and an ultraviolet absorbing agent. Specific examples include a hindered phenol compound, a hindered amine compound, a sulfur compound, a phosphorus compound and a benzophenone compound.

It is preferable for the average film thickness of the charge generation layer to be 0.1 to 1 μm, and is more preferable to be 0.15 to 0.4 μm.

The charge generation layer can be formed by operations of: preparing a coating liquid for charge generation layer, which contains each of the above materials and a solvent; forming a coating film of the coating liquid on the electroconductive layer or the undercoat layer; and drying the coating film. Examples of the solvent to be used for the coating liquid for the charge generation layer include an alcohol-based solvent, a sulfoxide-based solvent, a ketone-based solvent, an ether-based solvent, an ester-based solvent and an aromatic hydrocarbon-based solvent.

(1-2) Charge Transport Layer

It is preferable that a charge transport layer contains a charge transport substance and a resin.

Examples of the charge transport substance include a polycyclic aromatic compound, a heterocyclic compound, a hydrazone compound, a styryl compound, an enamine compound, a benzidine compound, a triarylamine compound, and resins having a group derived from these substances. Among the substances, the triarylamine compound and the benzidine compound are preferable.

It is preferable for a content of the charge transport substance in the charge transport layer to be 25 to 70% by mass, and is more preferable to be 30 to 55% by mass, with respect to the total mass of the charge transport layer.

Examples of the resin include a polyester resin, a polycarbonate resin, an acrylic resin and a polystyrene resin. Among the resins, the polycarbonate resin and the polyester resin are preferable. Among the polyester resins, a polyarylate resin is particularly preferable.

A content ratio (mass ratio) between the charge transport substance and the resin is preferably 4:10 to 20:10, and is more preferably 5:10 to 12:10.

In addition, the charge transport layer may contain additives such as an antioxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for an average film thickness of the charge transport layer to be 5 to 50 μm, is more preferable to be 8 to 40 μm, and is particularly preferable to be 9 to 30 μm.

The charge transport layer can be formed by operations of: preparing a coating liquid for the charge transport layer, which contains each of the above materials and a solvent; forming a coating film of the coating liquid on the charge generation layer; and drying the coating film. Examples of the solvent to be used for the coating liquid for the charge transport layer include an alcohol-based solvent, a ketone-based solvent, an ether-based solvent, an ester-based solvent and an aromatic hydrocarbon-based solvent. Among these solvents, the ether-based solvent or the aromatic hydrocarbon-based solvent is preferable.

(2) Single-Layer Type Photosensitive Layer

The single-layer type photosensitive layer can be formed by operations of: preparing a coating liquid for the photosensitive layer, which contains a charge generation substance, a charge transport substance, a resin and a solvent; forming a coating film of the coating liquid on the electroconductive layer or the undercoat layer; and drying the coating film. The charge generation substance, the charge transport substance and the resin are the same as the examples of the materials in the above “(1) Multilayer type photosensitive layer”.

<Protective Layer>

In the present disclosure, a protective layer may also be provided on the photosensitive layer. The protective layer which has been provided can thereby improve the durability.

It is preferable that the protective layer contains an electroconductive particle and/or a charge transport substance and a resin.

Examples of the electroconductive particle include particles of metal oxides such as titanium oxide, zinc oxide, tin oxide and indium oxide.

Examples of the charge transport substance include a polycyclic aromatic compound, a heterocyclic compound, a hydrazone compound, a styryl compound, an enamine compound, a benzidine compound, a triarylamine compound, and resins having a group derived from these substances. Among the substances, the triarylamine compound and the benzidine compound are preferable.

Examples of the resin include a polyester resin, an acrylic resin, a phenoxy resin, a polycarbonate resin, a polystyrene resin, a phenol resin, a melamine resin and an epoxy resin. Among the resins, the polycarbonate resin, the polyester resin and the acrylic resin are preferable.

In addition, the protective layer may be formed as a cured film by the polymerization of a composition which contains a monomer having a polymerizable functional group. Examples of the reaction at this time include a thermal polymerization reaction, a photopolymerization reaction, and a radiation-induced polymerization reaction. Examples of the polymerizable functional group which the monomer having a polymerizable functional group has include an acrylic group and a methacrylic group. As a monomer having the polymerizable functional group, a material having charge transport capability may be used.

The protective layer may contain additives such as an antioxidizing agent, an ultraviolet absorbing agent, a plasticizing agent, a leveling agent, a slipperiness imparting agent and an abrasion resistance improver. The specific additives include a hindered phenol compound, a hindered amine compound, a sulfur compound, a phosphorus compound, a benzophenone compound, a siloxane modified resin, silicone oil, a fluorocarbon resin particle, a polystyrene resin particle, a polyethylene resin particle, a silica particle, an alumina particle and a boron nitride particle.

It is preferable for an average film thickness of the protective layer to be 0.5 to 10 μm, and is more preferable to be 1 to 7 μm.

The protective layer can be formed by operations of: preparing a coating liquid for the protective layer, which contains each of the above materials and a solvent; forming a coating film of the coating liquid on the photosensitive layer; and drying and/or curing the coating film. Examples of the solvent to be used for the coating liquid for the protective layer include an alcohol-based solvent, a ketone-based solvent, an ether-based solvent, a sulfoxide-based solvent, an ester-based solvent and an aromatic hydrocarbon-based solvent.

[Process Cartridge and Electrophotographic Apparatus]

The process cartridge of the present disclosure integrally supports: the electrophotographic photosensitive member described above; and at least one unit selected from the group consisting of a charging unit, a developing unit and a cleaning unit; and is attachable to and detachable from a main body of an electrophotographic apparatus.

In addition, the electrophotographic apparatus of the present disclosure includes the electrophotographic photosensitive member described above, the charging unit, an exposure unit, the developing unit and a transfer unit.

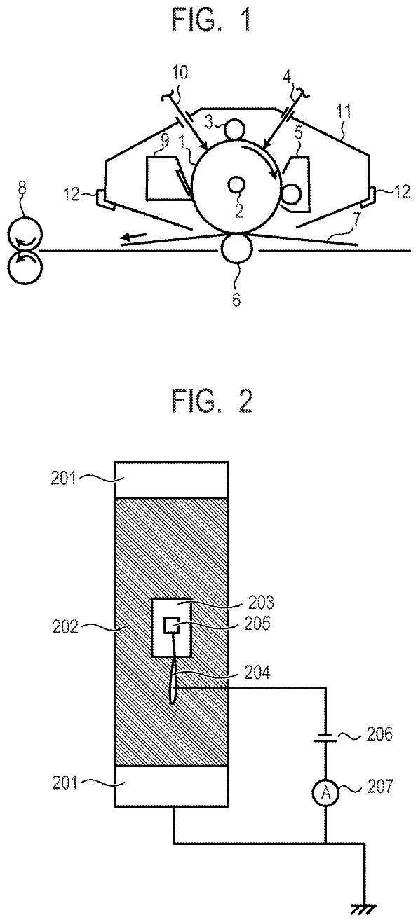

FIG. 1 illustrates an example of a schematic configuration of the electrophotographic apparatus having the process cartridge including the electrophotographic photosensitive member.

A cylindrical electrophotographic photosensitive member 1 is illustrated, which is rotationally driven around a shaft 2 in an arrow direction at a predetermined circumferential velocity. The surface of the electrophotographic photosensitive member 1 is charged to a predetermined positive or negative potential by a charging unit 3. For information, in the figure, a roller charging system by a roller type charging member is illustrated, but a charging system such as a corona charging system, a proximity charging system or an injection charging system may also be adopted. The surface of the charged electrophotographic photosensitive member 1 is irradiated with exposure light 4 emitted from an exposure unit (not illustrated), and an electrostatic latent image corresponding to objective image information is formed on the surface. The electrostatic latent image formed on the surface of the electrophotographic photosensitive member 1 is developed by a toner accommodated in a developing unit 5, and a toner image is formed on the surface of the electrophotographic photosensitive member 1. The toner image formed on the surface of the electrophotographic photosensitive member 1 is transferred onto a transfer material 7 by a transfer unit 6. The transfer material 7 to which the toner image has been transferred is conveyed to a fixing unit 8, is subjected to fixing treatment of the toner image, and is printed out to the outside of the electrophotographic apparatus. The electrophotographic apparatus may have a cleaning unit 9 for removing an adherent such as a toner remaining on the surface of the electrophotographic photosensitive member 1 after transferring. Alternatively, a cleaning unit may not be separately provided, but a so-called cleanerless system may be used that removes the above adherent by a developing unit or the like. The electrophotographic apparatus may have a neutralization mechanism that subjects the surface of the electrophotographic photosensitive member 1 to neutralization treatment by pre-exposure light 10 emitted from a pre-exposure unit (not illustrated). In addition, a guiding unit 12 such as a rail may also be provided in order to attach to and detach from a process cartridge 11 of the present disclosure to a main body of the electrophotographic apparatus.

The electrophotographic photosensitive member of the present disclosure can be used in a laser beam printer, an LED printer, a copying machine, a facsimile, a combined machine thereof and the like.

### EXAMPLES

The present disclosure will be described below in more detail with reference to Examples and Comparative Examples. The present disclosure is not limited to the following Examples at all, as long as the present disclosure does not exceed the gist thereof. Herein, “part(s)” in the following Examples is on a mass basis unless otherwise particularly noted.

[Production of Metal Oxide Particle]

(Metal Oxide Particle 1)

Titanium dioxide of the core material can be produced by a heretofore known sulfuric acid method. Specifically, the titanium dioxide is obtained by operations of: heating a solution containing titanium sulfate or titanyl sulfate to hydrolyze the chemical compound to produce a metatitanic acid slurry; and dehydrating and firing the metatitanic acid slurry.

As the core material particles, anatase type titanium oxide particles were used which had an average primary particle diameter of 200 nm. A titanium niobium sulfate solution was prepared which contained 33.7 g of titanium in terms of TiO₂ and 2.9 g of niobium in terms of Nb₂O₅. In pure water, 100 g of the core material particles were dispersed to prepare 1 L of a suspension liquid, and the suspension liquid was heated to 60° C. The titanium niobium sulfate solution and a 10 mol/L solution of sodium hydroxide were added dropwise to the suspension liquid over 3 hours so that a pH of the suspension liquid became 2 to 3. After the whole quantity was added dropwise, the pH was adjusted to the vicinity of neutrality, and a flocculant was added to precipitate a solid content. The supernatant was removed, the rest was filtered, and the residue was cleaned and then dried at 110° C. to obtain an intermediate which contained 0.1 wt % of an organic substance which was derived from the flocculant, in terms of C. This intermediate was calcined in nitrogen gas at 800° C. for 1 hour, and a metal oxide particle 1 was produced.

[Preparation of Coating Liquid for Electroconductive Layer]

(Coating Liquid 1 for Electroconductive Layer)

A solution was obtained by an operation of dissolving 80 parts of phenolic resin (phenolic resin monomer/oligomer) (trade name: Priofen J-325, produced by DIC Corporation, resin solid content: 60%, and density after curing: 1.3 g/cm²) which worked as a binder resin in 60 parts of 1-methoxy-2-propanol which worked as a solvent.

A dispersion liquid was obtained by operations of: adding 100 parts of the metal oxide particle 1 to the solution, which were an electroconductive material particle; charging the resultant liquid into a vertical sand mill which used 200 parts of glass beads having an average particle size of 1.0 mm as a dispersion medium; and subjecting the mixture to dispersion treatment under the conditions of a dispersion liquid temperature of 23±3° C. and a number of revolutions of 1500 rpm (circumferential velocity: 5.5 m/s) for 2 hours. The glass beads were removed from the dispersion liquid by a mesh (opening: 150 μm). A dispersion liquid from which the glass beads were removed was pressurized and filtrated using a PTFE filter paper (trade name: PF060, produced by Advantec Toyo Kaisha, Ltd.).

Silica particles (average primary particle diameter: 50 nm) which worked as a surface roughening material were added to the dispersion liquid so as to be 1.5% by mass, with respect to the total mass of the metal oxide particles and the binder resins in the dispersion liquid after pressure filtration; and silicone oil (trade name: SH28PA, produced by Dow Corning Toray Co., Ltd.) which worked as a leveling agent was added to the dispersion liquid so as to be 0.01% by mass, with respect to the total mass of the metal oxide particles and the binder resins in the dispersion liquid.

Next, a coating liquid 1 for an electroconductive layer was prepared by operations of: adding a mixed solvent of methanol and 1-methoxy-2-propanol (mass ratio 1:1) to the dispersion liquid so that the total mass (mass of solid content) of the metal oxide particles, the binder resin and the surface roughening material in the dispersion liquid was 67% by mass with respect to the mass of the dispersion liquid; and stirring the resultant liquid.

(Coating Liquids 2 to 18 for Electroconductive Layer)

The particle diameter of the metal oxide particle (electroconductive material particle) and the particle diameter of the silica particle were changed as in Table 1, where the particles were used in the preparation of the coating liquid 1 for the electroconductive layer. In addition, the amounts of the metal oxide particle (electroconductive material particle) and the silica particle to be added were changed so that the electrophotographic photosensitive members produced from the coating liquids became as in Table 2. Coating liquids 2 to 18 for electroconductive layers were prepared in the same manner as in the preparation of the coating liquid 1 for the electroconductive layer, except for the above conditions.

(Coating Liquid 19 for Electroconductive Layer)

A dispersion liquid was obtained by operations of: charging 207 parts of titanium oxide (TiO₂) particles (average primary particle diameter 230 nm) that are coated with tin oxide (SnO₂) doped with phosphorus (P), which served as metal oxide particles (electroconductive material particles), 144 parts of a phenol resin (monomer/oligomer of phenol resin) (trade name: Priofen J-325, produced by DIC Corporation, and resin solid content: 60% by mass) which worked as a binder resin, and 98 parts of 1-methoxy-2-propanol which worked as solvent, into a vertical sand mill which used 450 parts of glass beads having a diameter of 1.0 mm; and subjecting the resulting liquid to dispersion treatment under the conditions of rotation speed: 2000 rpm, dispersion treatment time: 4.5 hours, and a set temperature of cooling water: 18° C. The glass beads were removed from the dispersion liquid by a mesh (opening: 150 μm). A dispersion liquid from which the glass beads were removed was pressurized and filtrated using a PTFE filter paper (trade name: PF060, produced by Advantec Toyo Kaisha, Ltd.).

Silica particles (average primary particle diameter: 50 nm) which worked as a surface roughening material were added to the dispersion liquid so as to be 1.5% by mass, with respect to the total mass of the metal oxide particles and the binder resins in the dispersion liquid after pressure filtration; and silicone oil (trade name: SH28PA produced by Dow Corning Toray Co., Ltd.) which worked as a leveling agent was added to the dispersion liquid so as to be 0.01% by mass, with respect to the total mass of the metal oxide particles and the binder resins in the dispersion liquid.

Next, a coating liquid 19 for an electroconductive layer was prepared by operations of: adding a mixed solvent of methanol and 1-methoxy-2-propanol (mass ratio 1:1) to the dispersion liquid so that the total mass (mass of solid content) of the metal oxide particles, the binder resin and the surface roughening material in the dispersion liquid was 67% by mass with respect to the mass of the dispersion liquid; and stirring the resultant liquid.

(Coating Liquid 20 for Electroconductive Layer)

A dispersion liquid was obtained by operations of: charging 214 parts of titanium oxide (TiO₂) particles (average primary particle diameter 230 nm) that are coated with oxygen deficiency type tin oxide (SnO₂), which served as metal oxide particles (electroconductive material particles), 132 parts of a phenol resin (monomer/oligomer of phenol resin) (trade name: Priofen J-325, produced by DIC Corporation, and resin solid content: 60% by mass), which worked as a binder resin, and 98 parts of 1-methoxy-2-propanol which worked as a solvent, into a sand mill which used 450 parts of glass beads having a diameter of 0.8 mm; subjecting the resulting liquid to dispersion treatment under the conditions of rotation speed: 2000 rpm, dispersion treatment time: 4.5 hours, and a set temperature of cooling water: 18° C. The glass beads were removed from the dispersion liquid by a mesh (opening: 150 μm). A dispersion liquid from which the glass beads were removed was pressurized and filtrated using a PTFE filter paper (trade name: PF060, produced by Advantec Toyo Kaisha, Ltd.).

Silica particles (average primary particle diameter: 50 nm) which worked as a surface roughening material were added to the dispersion liquid so as to be 1.5% by mass, with respect to the total mass of the metal oxide particles and the binder resin in the dispersion liquid after pressure filtration; and silicone oil (trade name: SH28PA produced by Dow Corning Toray Co., Ltd.) which worked as a leveling agent was added to the dispersion liquid so as to be 0.01% by mass, with respect to the total mass of the metal oxide particles and the binder resins in the dispersion liquid.

Next, a coating liquid 20 for an electroconductive layer was prepared by operations of: adding a mixed solvent of methanol and 1-methoxy-2-propanol (mass ratio 1:1) to the dispersion liquid so that the total mass (mass of solid content) of the metal oxide particles, the binder resin and the surface roughening material in the dispersion liquid was 67% by mass with respect to the mass of the dispersion liquid; and stirring the resultant liquid.

(Coating Liquid 21 for Electroconductive Layer)

A solution was obtained by an operation of dissolving 80 parts of a phenolic resin (phenolic resin monomer/oligomer) (trade name: Priofen J-325, produced by DIC Corporation, resin solid content: 60%, and density after curing: 1.3 g/cm²) which worked as a binder resin, in 60 parts of 1-methoxy-2-propanol which worked as a solvent.

A dispersion liquid was obtained by operations of: adding 100 parts of rutile type titanium oxide (average primary particle diameter 50 nm) which was a metal oxide particle (electroconductive material particle) to the solution; charging the resultant liquid into a vertical sand mill which used 200 parts of glass beads having an average particle diameter of 1.0 mm as a dispersion medium; and subjecting the mixture to dispersion treatment under the conditions of a dispersion liquid temperature of 23±3° C. and a number of revolutions of 1500 rpm (circumferential velocity: 5.5 m/s) for 2 hours. The glass beads were removed from the dispersion liquid by a mesh. A dispersion liquid from which the glass beads were removed was pressurized and filtrated using a PTFE filter paper (trade name: PF060, produced by Advantec Toyo Kaisha, Ltd.).

Silica particles (average primary particle diameter: 50 nm) which worked as a surface roughening material were added to the dispersion liquid so as to be 1.5% by mass, with respect to the total mass of the metal oxide particles and the binder resin in the dispersion liquid after pressure filtration; and silicone oil (trade name: SH28PA produced by Dow Corning Toray Co., Ltd.) which worked as a leveling agent was added to the dispersion liquid so as to be 0.01% by mass, with respect to the total mass of the metal oxide particles and the binder resin in the dispersion liquid.

Next, a coating liquid 21 for an electroconductive layer was prepared by operations of: adding a mixed solvent of methanol and 1-methoxy-2-propanol (mass ratio 1:1) to the dispersion liquid so that the total mass (mass of solid content) of the metal oxide particles, the binder resin and the surface roughening material in the dispersion liquid was 67% by mass with respect to the mass of the dispersion liquid; and stirring the resultant liquid.

(Coating Liquid C1 for Electroconductive Layer)

A solution was obtained by an operation of dissolving 80 parts of a phenolic resin (phenolic resin monomer/oligomer) (trade name: Priofen J-325, produced by DIC Corporation, resin solid content: 60%, and density after curing: 1.3 g/cm²) which worked as a binder resin, in 60 parts of 1-methoxy-2-propanol which worked as a solvent.

A dispersion liquid was obtained by operations of: adding 100 parts of rutile type titanium oxide (average primary particle diameter 35 nm, primary surface treatment: silica-alumina treatment, and secondary surface treatment: methylhydrogenpolysiloxane [MHPS] treatment), which served as a metal oxide particle (electroconductive material particle); charging the resultant liquid into a vertical sand mill which used 200 parts of glass beads having an average particle diameter of 1.0 mm as a dispersion medium; and subjecting the mixture to dispersion treatment under the conditions of a dispersion liquid temperature of 23±3° C. and a number of revolutions of 1500 rpm (circumferential velocity: 5.5 m/s) for 2 hours. The glass beads were removed from the dispersion liquid by a mesh. A dispersion liquid from which the glass beads were removed was pressurized and filtrated using a PTFE filter paper (trade name: PF060, produced by Advantec Toyo Kaisha, Ltd.).

A silica particle (Godball B-6C, produced by SUZUKI YUSHI KOGYO CO., LTD., and average primary particle diameter: 2300 nm) which worked as a surface roughening material was added to the dispersion liquid so as to be 10.0% by mass, with respect to the total mass of the metal oxide particles and the binder resin in the dispersion liquid after pressure filtration; and silicone oil (trade name: SH28PA produced by Dow Corning Toray Co., Ltd.) which worked as a leveling agent was added to the dispersion liquid so as to be 0.01% by mass, with respect to the total mass of the metal oxide particles and the binder resin in the dispersion liquid. In this way, a coating liquid C1 for an electroconductive layer was prepared.

(Coating Liquids C2 to C8 for Electroconductive Layer)

The particle diameter of the metal oxide particle (electroconductive material particle) and the particle diameter of the silica particle were changed as in Table 1, where the particles were used in the preparation of the coating liquid 1 for the electroconductive layer. In addition, the amounts of the metal oxide particle (electroconductive material particle) and the silica particle to be added were changed so that the electrophotographic photosensitive member produced from the coating liquid became as in Table 2. Coating liquids C2 to C8 for electroconductive layers were prepared in the same manner as in the preparation of the coating liquid 1 for the electroconductive layer, except for the above conditions.

<Production of Electrophotographic Photosensitive Member>

(Electrophotographic Photosensitive Member 1)

An aluminum cylinder (JIS-A3003, aluminum alloy) was used as a support, which had a length of 257 mm and a diameter of 24 mm and was produced by a manufacturing method including an extrusion step and a drawing step.

An electroconductive layer having a film thickness of 25 μm was formed by operations of: applying the coating liquid 1 for the electroconductive layer onto the support by a dipping method, under an environment of normal temperature and normal humidity (23° C./50% RH); and drying and thermally curing the obtained coating film at 150° C. for 30 minutes. The volume resistivity of the electroconductive layer was measured by the method described above, and was consequently 1×10⁹ Ω·cm.

Next, a coating liquid 1 for an undercoat layer was prepared by an operation of dissolving 4.5 parts of N-methoxymethylated nylon (trade name: Toresin EF-30T, produced by Nagase Chemtex Corporation), and 1.5 parts of a copolymerized nylon resin (trade name: AMILAN™ CM8000, produced by Toray Industries, Inc.), in a mixed solvent of 65 parts of methanol/30 parts of n-butanol. An undercoat layer having a film thickness of 0.85 μm was formed by operations of: applying the coating liquid 1 for the undercoat layer onto an electroconductive layer by a dipping method; and drying the obtained coating film at 70° C. for 6 minutes.

Next, a coating liquid for a charge generation layer was prepared by operations of: charging 10 parts of a hydroxygallium phthalocyanine crystal (charge generation substance) which had a crystal form having strong peaks at 7.5 degrees, 9.9 degrees, 16.3 degrees, 18.6 degrees, 25.1 degrees and 28.3 degrees of Bragg angles (20±0.2 degrees) in CuKα characteristic X-ray diffraction, 5 parts of polyvinyl butyral (trade name: S-LEC BX-1, produced by Sekisui Chemical Co., Ltd.), and 250 parts of cyclohexanone, into a sand mill which used glass beads having a diameter of 0.8 mm; subjecting the resultant liquid to dispersion treatment under the conditions of dispersion treatment time: 3 hours; and adding 250 parts of ethyl acetate thereto. A charge generation layer having a film thickness of 0.15 μm was formed by operations of: applying this coating liquid for the charge generation layer onto the undercoat layer by a dipping method; and drying the obtained coating film at 100° C. for 10 minutes.

Next, a coating liquid for a charge transport layer was prepared by an operation of dissolving 6.0 parts of an amine compound (charge transport substance) represented by the following formula (CT-1), 2.0 parts of an amine compound (charge transport substance) represented by the following formula (CT-2), and 10 parts of a bisphenol Z type of polycarbonate (trade name: Z400, produced by Mitsubishi Engineering-Plastics Corporation), and 0.36 parts of a siloxane-modified polycarbonate which has a repeating structural unit represented by the following formula (B-1) and a repeating structural unit represented by the following formula (B-2), and has a terminal structure represented by the following formula (B-3), and in which (B-1):(B-2)=95:5 (molar ratio), in a mixed solvent of 60 parts of o-xylene/40 parts of dimethoxymethane/2.7 parts of methyl benzoate. A charge transport layer having a film thickness of 12.0 μm was formed by operations of: applying this coating liquid for the charge transport layer onto the charge generation layer by a dipping method; and drying an obtained coating film at 125° C. for 30 minutes.

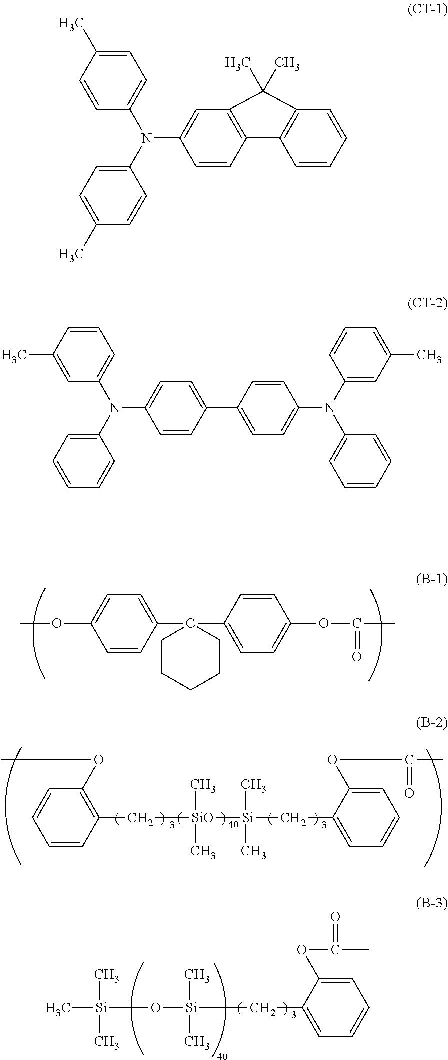

Thus, an electrophotographic photosensitive member 1 was produced in which the charge transport layer was a surface layer.

(Electrophotographic Photosensitive Members 2 to 25 and C1 to C8)

The coating liquid for an electroconductive layer used in the production of the electrophotographic photosensitive member was changed from the coating liquid 1 for an electroconductive layer to coating liquids 2 to 21 and C1 to C8 for electroconductive layers as shown in Table 2. Furthermore, electrophotographic photosensitive members 2 to 25 and C1 to C8 in which the charge transporting layers were the surface layer were produced in the same manner as in the production of the electrophotographic photosensitive member 1 except that the film thicknesses of the electroconductive layers were changed as shown in Table 2. Note that electrophotographic photosensitive members 11, 12, 13 and 14 used the coating liquid 1 for the electroconductive layer. The results are shown in Table 2.

TABLE 1
Table 1

| | Particle diameter | Resistivity of | |
|---|---|---|---|
| Coating liquid | of electrocon- | electroconductive | Particle diameter |
| for electrocon- | ductive material | material particle | of silica particle |
| ductive layer | particle nm | Ω · cm | nm |
| 1 | 240 | 1.3 × 10⁵ | 50 |
| 2 | 240 | 1.3 × 10⁵ | 50 |
| 3 | 240 | 1.3 × 10⁵ | 50 |
| 4 | 50 | 1.5 × 10⁵ | 50 |
| 5 | 400 | 1.4 × 10⁵ | 50 |
| 6 | 500 | 1.2 × 10⁵ | 50 |
| 7 | 240 | 1.3 × 10⁵ | 10 |
| 8 | 240 | 1.3 × 10⁵ | 100 |
| 9 | 240 | 1.3 × 10⁵ | 120 |
| 10 | 240 | 1.3 × 10⁵ | 300 |
| 11 | 240 | 2.1 × 10⁰ | 50 |
| 12 | 240 | 1.4 × 10¹ | 50 |
| 13 | 240 | 1.2 × 10⁸ | 50 |
| 14 | 240 | 1.1 × 10⁹ | 50 |
| 15 | 240 | 1.3 × 10⁵ | 50 |
| 16 | 240 | 1.3 × 10⁵ | 50 |
| 17 | 240 | 1.3 × 10⁵ | 50 |
| 18 | 240 | 1.3 × 10⁵ | 50 |
| 19 | 210 | 4.2 × 10³ | 50 |
| 20 | 200 | 3.5 × 10² | 50 |
| 21 | 50 | 2.5 × 10⁶ | 50 |
| C1 | 35 | 3.3 × 10⁹ | 2300 |
| C2 | 240 | 1.3 × 10⁵ | 50 |
| C3 | 240 | 1.3 × 10⁵ | 50 |
| C4 | 35 | 1.3 × 10⁵ | 50 |
| C5 | 560 | 1.7 × 10⁵ | 50 |
| C6 | 240 | 1.3 × 10⁵ | 5 |
| C7 | 240 | 1.3 × 10⁵ | 340 |
| C8 | 240 | 1.3 × 10⁵ | — |

TABLE 2
Table 2

| | | | Content of | Particle | | |
|---|---|---|---|---|---|---|
| Electrophotographic | | Particle diameter of | electroconductive | diameter of | Content of | Film thickness of |
| photosensitive | Coating liquid for electroconductive | electroconductive | material particle | silica | silica particle | electroconductive |
| member | layer | material particle nm | % by volume | particle nm | % by volume | layer μm |
| 1 | Coating liquid for electroconductive | 240 | 39.4 | 50 | 1.38 | 25 |
| | layer 1 | | | | | |
| 2 | Coating liquid for electroconductive | 240 | 20.0 | 50 | 1.38 | 25 |
| | layer 2 | | | | | |
| 3 | Coating liquid for electroconductive | 240 | 60.0 | 50 | 1.38 | 25 |
| | layer 3 | | | | | |
| 4 | Coating liquid for electroconductive | 50 | 39.4 | 25 | 1.38 | 25 |
| | layer 4 | | | | | |
| 5 | Coating liquid for electroconductive | 400 | 39.4 | 25 | 1.38 | 25 |
| | layer 5 | | | | | |
| 6 | Coating liquid for electroconductive | 500 | 39.4 | 50 | 1.38 | 25 |
| | layer 6 | | | | | |
| 7 | Coating liquid for electroconductive | 240 | 39.4 | 10 | 1.38 | 25 |
| | layer 7 | | | | | |
| 8 | Coating liquid for electroconductive | 240 | 39.4 | 100 | 1.38 | 25 |
| | layer 8 | | | | | |
| 9 | Coating liquid for electroconductive | 240 | 39.4 | 120 | 1.38 | 25 |
| | layer 9 | | | | | |
| 10 | Coating liquid for electroconductive | 240 | 39.4 | 300 | 1.38 | 25 |
| | layer 10 | | | | | |
| 11 | Coating liquid for electroconductive | 240 | 39.4 | 50 | 1.38 | 5 |
| | layer 1 | | | | | |
| 12 | Coating liquid for electroconductive | 240 | 39.4 | 50 | 1.38 | 3 |
| | layer 1 | | | | | |
| 13 | Coating liquid for electroconductive | 240 | 39.4 | 50 | 1.38 | 50 |
| | layer 1 | | | | | |
| 14 | Coating liquid for electroconductive | 240 | 39.4 | 50 | 1.38 | 60 |
| | layer 1 | | | | | |
| 15 | Coating liquid for electroconductive | 240 | 39.4 | 50 | 1.38 | 25 |
| | layer 11 | | | | | |
| 16 | Coating liquid for electroconductive | 240 | 39.4 | 50 | 1.38 | 25 |
| | layer 12 | | | | | |
| 17 | Coating liquid for electroconductive | 240 | 39.4 | 50 | 1.38 | 25 |
| | layer 13 | | | | | |
| 18 | Coating liquid for electroconductive | 240 | 39.4 | 50 | 1.38 | 25 |
| | layer 14 | | | | | |
| 19 | Coating liquid for electroconductive | 240 | 39.4 | 50 | 0.05 | 25 |
| | layer 15 | | | | | |
| 20 | Coating liquid for electroconductive | 240 | 39.4 | 50 | 0.10 | 25 |
| | layer 16 | | | | | |
| 21 | Coating liquid for electroconductive | 240 | 39.4 | 50 | 2.00 | 25 |
| | layer 17 | | | | | |
| 22 | Coating liquid for electroconductive | 240 | 39.4 | 50 | 3.61 | 25 |
| | layer 18 | | | | | |
| 23 | Coating liquid for electroconductive | 210 | 36.7 | 50 | 1.64 | 30 |
| | layer 19 | | | | | |
| 24 | Coating liquid for electroconductive | 200 | 40.8 | 50 | 1.66 | 30 |
| | layer 20 | | | | | |
| 25 | Coating liquid for electroconductive | 50 | 37.7 | 50 | 1.42 | 10 |
| | layer 21 | | | | | |
| C1 | Coating liquid for electroconductive | 35 | 46.4 | 2300 | 7.23 | 10 |
| | layer C1 | | | | | |
| C2 | Coating liquid for electroconductive | 240 | 18.0 | 50 | 1.38 | 25 |
| | layer C2 | | | | | |
| C3 | Coating liquid for electroconductive | 240 | 67.0 | 50 | 1.38 | 25 |
| | layer C3 | | | | | |
| C4 | Coating liquid for electroconductive | 35 | 39.4 | 50 | 1.38 | 25 |
| | layer C4 | | | | | |
| C5 | Coating liquid for electroconductive | 560 | 39.4 | 50 | 1.38 | 25 |
| | layer C5 | | | | | |
| C6 | Coating liquid for electroconductive | 240 | 39.4 | 5 | 1.38 | 25 |
| | layer C6 | | | | | |
| C7 | Coating liquid for electroconductive | 240 | 39.4 | 340 | 1.38 | 25 |
| | layer C7 | | | | | |
| C8 | Coating liquid for electroconductive | 240 | 40.0 | — | 0.00 | 25 |
| | layer C8 | | | | | |

(Analysis of Electroconductive Layer of Electrophotographic Photosensitive Member)

Five slices of 5 mm square were cut out from each of the electrophotographic photosensitive members produced above, and then, the charge transport layer and the charge generation layer in each slice were wiped off with chlorobenzene, methyl ethyl ketone and methanol, and the electroconductive layer was exposed. In this way, five sample pieces for observation were prepared for each of the electrophotographic photosensitive members.

Firstly, for each of the electrophotographic photosensitive members, an electroconductive layer of one sample piece was formed into a thin slice having a thickness of 150 nm, by an FIB-μ sampling method using a focused ion beam machining observation apparatus (trade name: FB-2000A, manufactured by Hitachi High-Tech Manufacturing & Service Corp.); and the composition of the electroconductive layer was analyzed using a field emission type electron microscope (HRTEM) (trade name: JEM-2100F, manufactured by JEOL Ltd.) and an energy dispersive X-ray analyzer (EDX) (trade name: JED-2300T, manufactured by JEOL Ltd.). For information, the measurement conditions for the EDX are as follows. Acceleration voltage: 200 kV, and beam size: 1.0 nm.

From the obtained EDX image, diameters of 100 individual particles of the metal oxide particle and the silica particle were measured, and the average primary particle diameter was obtained from the arithmetic average thereof.

Next, for each of the electrophotographic photosensitive members, the remaining four sample pieces were used, and a three-dimensional image of 2 μm×2 μm×2 μm of the electroconductive layer was determined by Slice & View of FIB-SEM. A content of each particle in the total volume of the electroconductive layer was calculated from the difference among contrasts in Slice & View of FIB-SEM. In the present Example, the conditions of Slice & View were set in the following way.

Machining of analytical sample: FIB method

Machining and observation apparatus: NVision40 produced by SII/Zeiss Co., Ltd.

Slice interval: 10 nm

Observation conditions:

Acceleration voltage: 1.0 kV

Sample tilt: 54°

WD: 5 mm

Detector: BSE detector

Aperture: 60 μm, high current

ABC: ON

Image resolution: 1.25 nm/pixel

An analysis region of length 2 μm×width 2 μm is subjected to the analysis, information on each cross section is integrated, and a volume V of length 2 μm×width 2 μm×thickness 2 μm (8 μm³) is determined. In addition, the measurement environment is a temperature of 23° C. and a pressure of 1×10⁻⁴ Pa. For information, Strata 400S manufactured by KAGA FEI Co., Ltd. (sample tilt: 52°) can also be used, as the machining and observation apparatus. The information for each cross section was obtained by image analysis of an area of the metal oxide particle specified in the present disclosure or the metal oxide particle used in the Comparative Example. The image was analyzed using image processing software: Image-Pro Plus manufactured by Media Cybernetics Inc.

Based on the obtained information, the volumes V of the metal oxide particles of the present disclosure or the metal oxide particles used in the Comparative Examples in volumes of 2 μm×2 μm×2 μm (unit volumes: 8 μm³) were determined in each of the four sample pieces. Then, (V μm³/8 μm³×100) was calculated. An average value of the values of (V μm³/8 μm³×100) in the four sample pieces was defined as a content [vol %] of the metal oxide particle (electroconductive material particle) or the silica particle in the present disclosure in the electroconductive layer, with respect to the total volume of the electroconductive layer. The results are shown in Table 2.

[Evaluation]

(Evaluation of Interference Fringes in Printed Image Through Electrophotographic Photosensitive Member)

Each of the electrophotographic photosensitive members produced above was mounted on a modified machine of a laser beam printer Color Laser Jet Enterprise M552 manufactured by Hewlett-Packard Company, and samples for interference fringe evaluation were output under an environment of a temperature of 23° C. and a relative humidity of 50%. As for the modified point, the charging conditions and a light amount of laser exposure were modified to be operated variably. The electrophotographic photosensitive member produced above was mounted on a process cartridge for black color, and the process cartridge was attached to a station for the process cartridge for the black color. Furthermore, the laser beam printer was modified so as to operate even though process cartridges for other colors (cyan, magenta and yellow) are not mounted on the main body of the laser beam printer.

An apparatus which had a potential probe (trade name: Model 6000B-8, manufactured by Trek Japan) mounted at a development position of the process cartridge was used for measurement of a surface potential of the electrophotographic photosensitive member, and the electric potential at the middle portion in the longitudinal direction of the electrophotographic photosensitive member was measured using a surface potential meter (trade name: Model 344, manufactured by Trek Japan).

An image to be evaluated was prepared by setting an electric charge potential Vd at −600 V, the exposure potential V1 at −200 V, and the development potential Vcdc at −400 V in the above apparatus; and using a half-tone image of a one-dot knight pattern. The evaluation criteria of the image are as follows. In the present application, rank B or higher is defined as a criterion in which interference fringes are sufficiently suppressed. The results are shown in Table 3.

A: Interference fringes are not generated at all.

B: Interference fringes are observed in a small part of the image, but cannot be observed in a practical image.

C: Interference fringes are observed in a wide range, which is an observable level depending on a type of the practical image.

D: Interference fringes are observed on the whole face of the image, and are observed also in the practical image.

(Evaluation of Fineness of Printed Image Through Electrophotographic Photosensitive Member)

Each of the electrophotographic photosensitive members produced above was mounted on a modified machine of a laser beam printer Color Laser Jet Enterprise M552 manufactured by Hewlett-Packard Company, and was subjected to a sheet feeding durability test under an environment of a temperature of 23° C. and a relative humidity of 50%. In the sheet feeding durability test, a printing operation was performed in an intermittent mode in which character images having a printing rate of 2% were output one by one on letter paper, and 3,000 sheets of images were output. Then, at the end of output of 3,000 sheets of images, samples for evaluating the fineness of the printed image were output. As for the modified point, the charging conditions and the light amount of laser exposure were modified to be operated variably. The electrophotographic photosensitive member produced above was mounted on a process cartridge for black color, and the process cartridge was attached to a station for the process cartridge for the black color. Furthermore, the laser beam printer was modified so as to operate even though process cartridges for other colors (cyan, magenta and yellow) are not mounted on the main body of the laser beam printer.

An apparatus which had a potential probe (trade name: Model 6000B-8, manufactured by Trek Japan) mounted at a development position of the process cartridge was used for measurement of a surface potential of the electrophotographic photosensitive member, and the electric potential at the middle portion in the longitudinal direction of the electrophotographic photosensitive member was measured using a surface potential meter (trade name: Model 344, manufactured by Trek Japan).

An image was used as the image to be evaluated, which was output by setting an electric charge potential Vd at −600 V, the exposure potential V1 at −200 V, and the development potential Vcdc at −400 V in the above apparatus; and using an image pattern in which every one dot was exposed at every interval of three dots (FIG. 4).

For the measurement of the image density, “REFLECTMETER MODEL TC-6DS” (manufactured by Tokyo Denshoku Co., Ltd.) was used, and the density [%] was calculated from the difference between the measured whiteness of the white background portion of the print-out hard copy of the image and whiteness of the dot patch. An amber filter was used as the filter. In the present application, the density of the print-out hard copy of the image (image density of isolated dot) of 8.0% or higher was defined as a criterion for clearly reproducing the exposed isolated dots. The results are shown in Table 3.

TABLE 3
Table 3

| Electro- | | | |
|---|---|---|---|
| photographic | Interference | Isolated | |
| photosensitive | fringe | dot image | |
| member | rank | density % | Remarks |
| 1 | A | 10.5 | |
| 2 | B | 10.2 | |
| 3 | A | 8.5 | |
| 4 | B | 10.1 | |
| 5 | A | 9.4 | |
| 6 | A | 10.0 | |
| 7 | A | 8.2 | |
| 8 | B | 10.0 | |
| 9 | B | 9.1 | |
| 10 | B | 8.3 | |
| 11 | A | 9.5 | |
| 12 | B | 8.7 | |
| 13 | B | 9.2 | |
| 14 | B | 8.3 | |
| 15 | B | 8.2 | Leak image occurred due |
| | | | to dielectric breakdown |
| | | | of photosensitive member |
| 16 | A | 9.3 | |
| 17 | A | 8.9 | |
| 18 | A | 8.2 | Low density occurred in |
| | | | image |
| 19 | C | 10.6 | |
| 20 | B | 10.5 | |
| 21 | A | 9.4 | |
| 22 | A | 8.3 | |
| 23 | A | 10.2 | |
| 24 | A | 10.3 | |
| 25 | B | 8.6 | |
| C1 | B | 5.5 | |
| C2 | C | 9.8 | |
| C3 | A | 7.1 | |
| C4 | C | 9.3 | |
| C5 | A | 7.2 | |
| C6 | C | 7.0 | |
| C7 | B | 7.3 | |
| C8 | D | 10.2 | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-087657, filed May 19, 2020, which is hereby incorporated by reference herein in its entirety.

What is claimed is:

1. An electrophotographic photosensitive member comprising a support, an electroconductive layer and a photosensitive layer, in this order, wherein
the electroconductive layer comprises a binder resin, a metal oxide particle and a silica particle,
a content of the metal oxide particle in the electroconductive layer is 20.0 to 60.0% by volume with respect to total volume of the electroconductive layer,
the metal oxide particle has an average primary particle diameter of 50 to 500 nm, and
the silica particle has an average primary particle diameter of 10 to 300 nm.

2. The electrophotographic photosensitive member according to claim 1, wherein the electroconductive layer has a film thickness of 5 to 50 μm.

3. The electrophotographic photosensitive member according to claim 1, wherein the metal oxide particle has a volume resistivity of 1.0×10¹ to 1.0×10⁸ Ω·cm.

4. The electrophotographic photosensitive member according to claim 1, wherein the silica particle has the average primary particle diameter of 10 to 100 nm.

5. The electrophotographic photosensitive member according to claim 1, wherein a content of the silica particle in the electroconductive layer is 0.10 to 2.00% by volume with respect to total volume of the electroconductive layer.

6. A process cartridge which integrally supports: an electrophotographic photosensitive member having a support, an electroconductive layer and a photosensitive layer in this order; and at least one unit selected from the group consisting of a charging unit, a developing unit and a cleaning unit; and is attachable to and detachable from a main body of an electrophotographic apparatus, wherein
the electroconductive layer comprises a binder resin, a metal oxide particle and a silica particle,
a content of the metal oxide particles in the electroconductive layer is 20.0 to 60.0% by volume with respect to total volume of the electroconductive layer,
the metal oxide particle has an average primary particle diameter of 50 to 500 nm, and
the silica particle has an average primary particle diameter of 10 to 300 nm.

7. An electrophotographic apparatus comprising:
an electrophotographic photosensitive member having a support, an electroconductive layer and a photosensitive layer in this order; and
a charging unit, an exposure unit, a developing unit and a transfer unit, wherein
the electroconductive layer comprises a binder resin, a metal oxide particle and a silica particle,
a content of the metal oxide particles in the electroconductive layer is 20.0 to 60.0% by volume with respect to total volume of the electroconductive layer,
the metal oxide particle has an average primary particle diameter of 50 to 500 nm, and
the silica particle has an average primary particle diameter of 10 to 300 nm.
